(19) United States
(12) Patent Application Publication
(10) Pub. No.: US 2019/0332371 A1
(43) Pub. Date: Oct. 31, 2019

(54) ON-BOARD UPDATE APPARATUS, UPDATE SYSTEM, AND PORTABLE COMMUNICATION DEVICE

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-Shi (JP)

(72) Inventor: Naoto Kobayashi, Yokkaichi, Mie (JP)

(21) Appl. No.: 16/470,638

(22) PCT Filed: Dec. 18, 2017
(86) PCT No.: PCT/JP2017/045288

§ 371 Date: Jun. 18, 2019

(30) Foreign Application Priority Data
Dec. 20, 2016 (JP) 2016-247162

(51) Int. Cl. G06F 8/65; G07C 5/08; G07C 5/00; H04W 4/029; H04W 4/40; B60W 50/00

(52) U.S. Cl. CPC G06F 8/65; G07C 5/085; G07C 5/008; B60R 16/023; H04W 4/40; B60W 50/00; H04W 4/029

(57) ABSTRACT

An update system performs update processing for updating a program or data stored in a storage unit of an on-board device installed in a vehicle, and includes a portable communication device that has a position detection unit that detects position information, and an on-board update apparatus that has a position information acquisition unit that acquires position information from the portable communication device, a position information storage unit that stores position information for permitting or prohibiting execution of the update processing, an update determination unit that determines whether or not the update processing can be executed, based on the position information acquired by the position information acquisition unit and the position information stored in the position information storage unit, and an updating unit that performs the update processing if the update determination unit determines that execution is permitted.

### CROSS-REFERENCE TO RELATED APPLICATIONS

This application is the U.S. national stage of PCT/JP2017/045288 filed on Dec. 18, 2017, which claims priority of Japanese Patent Application No. JP 2016-247162 filed on Dec. 20, 2016, the contents of which are incorporated herein.

### TECHNICAL FIELD

The present disclosure relates to an on-board update apparatus, an update system, and a portable communication device for updating programs or data in on-board devices installed in a vehicle.

### BACKGROUND

A vehicle is conventionally equipped with a plurality of on-board devices such as ECUs (electronic control units), which are connected via communication lines such as CAN (controller area network) buses and thereby capable of transmitting and receiving information to and from each other. Each ECU performs various types of processing such as control of a vehicle, by a processor that includes a CPU (central processing unit) reading out and executing programs stored in a storage unit such as a flash memory or EEPROM (electrically erasable programmable read only memory). A program or data stored in the storage unit of each ECU needs to be updated with a new program or data when it is required to add a function, correct a fault, upgrade the program or data, etc. In this case, the update program or data is transmitted via a communication line to the ECU to be updated.

JP 2011-53954A describes a software update apparatus for updating programs of a vehicle during an unoccupied time period during which the user does not use the vehicle. This software update apparatus estimates an unoccupied time period during which programs can be updated, informs the user of the estimated unoccupied time period, and updates the programs during an unoccupied time period designated by the user. Also, when informing the user of an unoccupied time period, the software update apparatus informs an estimated position of the vehicle during the unoccupied time period.

While update processing of an on-board device is being performed, this on-board device cannot perform a normal operation, and thus the vehicle cannot run. In some cases, update processing requires about several minutes to several tens of minutes, and the user cannot use the vehicle during this period. Therefore, before update processing is performed, the user is inquired whether or not to permit update processing to be performed, and only if the user permits update processing, update processing is performed. However, there is a possibility that the user permits update processing accidentally due to an erroneous input operation or the like. For example, when the user goes out on a trip or for shopping in a vehicle, and update processing is permitted there due to an erroneous input operation, there is a risk that the user cannot use the vehicle there until this update processing ends.

The present disclosure has been made in light of the above-described issue, and aims to provide an on-board update apparatus, an update system, and a portable communication device that can prevent update processing of an on-board device from being performed in an inappropriate place.

### SUMMARY

An on-board update apparatus according to the present disclosure causes an on-board device installed in a vehicle to execute update processing for updating a program or data stored in a storage unit of the on-board device, and includes a position information acquisition unit that acquires position information, a position information storage unit that stores position information for permitting or prohibiting execution of the update processing, an update determination unit that determines whether or not the update processing can be executed, based on the position information acquired by the position information acquisition unit and the position information stored in the position information storage unit, and an updating unit that causes the on-board device to execute the update processing if the update determination unit determines that the update processing can be executed.

In addition, the on-board update apparatus according to the present disclosure may further include a vehicle state information acquisition unit that acquires state information regarding running of the vehicle, and, when the vehicle changes from a running state to a parked state, the update determination unit may determine whether or not the update processing can be executed, based on the state information acquired by the vehicle state information acquisition unit.

In addition, the on-board update apparatus according to the present disclosure may further include an inquiry unit that inquires, if the update determination unit determines that the update processing can be executed, whether or not the update processing can be performed, and a receiving unit that receives a response regarding whether or not the update processing can be performed, to the inquiry of the inquiry unit.

In addition, the on-board update apparatus according to the present disclosure may include a communication unit that communicates with a portable communication device that has a position detection unit that detects position information, and the position information acquisition unit may acquire position information from the portable communication device.

In addition, an update system according to the present disclosure performs update processing for updating a program or data stored in a storage unit of an on-board device installed in a vehicle, and includes a portable communication device that has a position detection unit that detects position information, and an on-board update apparatus that has a position information acquisition unit that acquires position information from the portable communication device, a position information storage unit that stores position information for permitting or prohibiting execution of the update processing, an update determination unit that determines whether or not the update processing can be executed, based on the position information acquired by the position information acquisition unit and the position information stored in the position information storage unit, and an updating unit that causes, if the update determination unit determines that the update processing can be executed, the on-board device to execute the update processing.

In addition, an update system according to the present disclosure performs update processing for updating a program or data stored in a storage unit of an on-board device installed in a vehicle, and includes a portable communication device that has a position detection unit that detects position information, a position information storage unit that stores position information for permitting or prohibiting execution of the update processing, and an update determination unit that determines whether or not the update processing can be executed, based on the position information detected by the position detection unit and the position information stored in the position information storage unit, and an on-board update apparatus that has a determination result acquisition unit that acquires, from the portable communication device, a determination result on whether or not the update processing can be executed, and an updating unit that causes the on-board device to execute the update processing, if it is determined that the update processing can be executed, based on the determination result on whether or not the update processing can be executed acquired by the determination result acquisition unit.

In addition, a portable communication device according to the present disclosure includes a position detection unit that detects position information, a position information storage unit that stores position information for permitting or prohibiting execution of update processing for updating a program or data stored in a storage unit of an on-board device installed in a vehicle, an update determination unit that determines whether or not the update processing can be executed, based on the position information detected by the position detection unit and the position information stored in the position information storage unit, and a determination result transmission unit that transmits a determination result of the update determination unit to an on-board update apparatus that performs the update processing.

In the present disclosure, the on-board update apparatus that causes this on-board device to execute update processing for updating a program or data stored in the storage unit of the on-board device stores position information for permitting or prohibiting execution of the update processing. Before the update processing is executed, the on-board update apparatus compares the position information at this point with the stored position information, and determines whether or not the update processing can be executed. If it is determined that the update processing can be performed, based on the position information, the on-board update apparatus causes the on-board device to execute the update processing.

Accordingly, update processing of the on-board device is performed in a place in which execution of update processing is permitted, and update processing is not performed in a place in which execution of update processing is not permitted. For example, by setting position information of the user's home as a position at which execution of update processing is permitted, update processing is not performed at a position other than this position, and it is possible to prevent the user from being unable to use the vehicle due to update processing when the user is out in the vehicle.

Note that, by storing a position at which update processing is permitted as position information related to whether or not update processing can be executed, for example, by the user of the vehicle registering, in advance, his or her parking lot as a position at which update processing is permitted, it is possible to easily limit a position at which update processing is performed. In addition, by storing positions at which update processing is prohibited, as the position information related to whether or not update processing can be executed, safety measures can be taken in which the manufacturing company, distributor, or the like of the vehicle registers, in advance, positions that are not appropriate for executing update processing, due to which the vehicle cannot be used, such as crime-filled regions, extremely hot or cold regions, and suburban regions such as deserts or mountains.

In addition, in the present disclosure, the on-board update apparatus acquires the state information of the vehicle, and when the vehicle changes from a running state to a parked state, determines whether or not update processing can be executed. Accordingly, update processing can be executed in a safe state in which the vehicle is not running.

In addition, in the present disclosure, if it is determined that update processing can be executed, the on-board update apparatus inquires whether or not to perform update processing, and receives, from the user, a response indicating whether or not update processing can be performed. If it is determined that update processing cannot be executed, the on-board update apparatus does not inquire the user. Accordingly, the inquiry is made to the user only at a position at which update processing can be performed, and it is possible to reduce the user's irritations from frequently repeated inquiries, and it is possible to prevent update processing from being permitted due to the inquiry being made at a position at which update processing cannot be performed and the user performing an erroneous operation.

In addition, in the present disclosure, the on-board update apparatus communicates with a portable communication device such as a mobile phone or a smartphone held by the user. The portable communication device has a function for detecting position information, and the on-board update apparatus acquires position information detected by the portable communication device, and performs determination. Accordingly, even if no apparatus that detects position information is installed in the vehicle, the on-board update apparatus can perform determination processing that is based on position information.

In addition, in the present disclosure, the portable communication device that has a function for detecting position information stores position information for permitting or prohibiting execution of update processing of the on-board device. The portable communication device compares the position information at this point with the stored position information, for example, according to a request from the on-board update apparatus, determines whether or not update processing can be executed, and transmits the determination result to the on-board update apparatus. The on-board update apparatus receives the determination result from the portable communication device, and if a determination result indicating that update processing can be performed is obtained, causes the on-board device to execute update processing. Accordingly, it is not necessary for the on-board update apparatus to store position information for permitting or prohibiting execution of update processing, and it is also unnecessary to perform processing for determining whether or not update processing can be performed based on position information, and thus the processing load of the on-board update apparatus can be reduced, and an reduction in the cost of the on-board update apparatus can be realized.

### Advantageous Effects of Disclosure

According to the present disclosure, by adopting a configuration in which position information for permitting or prohibiting execution of update processing is stored, the position information at this point is compared with the stored position information before update processing is executed, and whether or not update processing can be executed is determined, it is possible to prevent update processing of on-board devices from being performed at an inappropriate place.

### BRIEF DESCRIPTION OF DRAWINGS

FIG. 1 is a block diagram showing the configuration of an update system according to an embodiment of the present disclosure.

FIG. 2 is a block diagram showing the configuration of an ECU according to an embodiment of the present disclosure.

FIG. 3 is a block diagram showing the configuration of a gateway according to a first embodiment.

FIG. 4 is a block diagram showing the configuration of a smartphone according to the first embodiment.

FIG. 5 is a flowchart showing the procedure of processing that is performed by the gateway according to the first embodiment.

FIG. 6 is a flowchart showing the procedure of processing that is performed by the gateway according to the first embodiment.

FIG. 7 is a flowchart showing the procedure of processing that is performed by the smartphone according to the first embodiment.

FIG. 8 is a block diagram showing the configuration of a gateway according to a second embodiment.

FIG. 9 is a block diagram showing the configuration of a smartphone according to the second embodiment.

FIG. 10 is a flowchart showing the procedure of processing that is performed by the gateway according to the second embodiment.

FIG. 11 is a flowchart showing the procedure of processing that is performed by the smartphone according to the second embodiment.

### DETAILED DESCRIPTION OF PREFERRED EMBODIMENTS

### First Embodiment

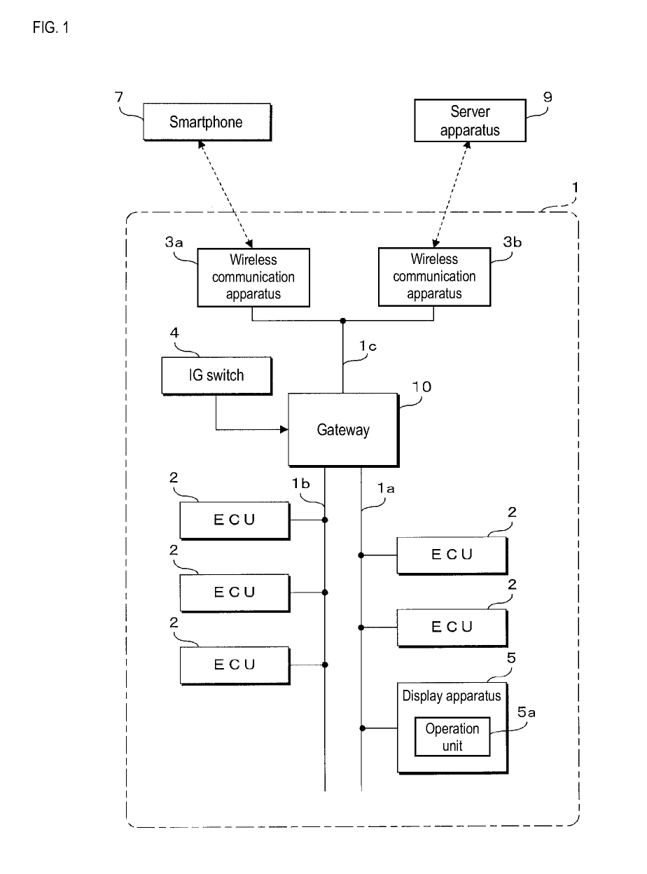

FIG. 1 is a block diagram showing the configuration of an update system according to the present embodiment. The update system according to the present embodiment is a system in which a plurality ECUs (electronic control units) 2 installed in a vehicle 1 communicate with each other via communication lines 1a and 1b and a gateway 10 arranged in the vehicle 1. In the update system according to the present embodiment, the gateway 10 corresponds to an on-board update apparatus, and the ECUs 2 correspond to on-board devices to be updated. In addition, the illustrated example, a system configuration is adopted in which two ECUs 2 and one display apparatus 5 are connected to the communication line 1a in the vehicle, three ECUs 2 are connected to the communication line 1b, and the two communication lines 1a and 1b are connected to the gateway 10, and it is possible to transmit/receive data between all of the ECUs 2 as a result of the gateway 10 relaying communication between the communication lines 1a and 1b.

In addition, in the update system according to the present embodiment, wireless communication apparatuses 3a and 3b are connected to the gateway 10 via a communication line 1c. The gateway 10 can communicate with a smartphone 7 that is inside or outside the vehicle, via the wireless communication apparatus 3a, and can communicate with a server apparatus 9 installed outside of the vehicle 1 via the wireless communication apparatus 3b. In addition, an IG (ignition) signal is input from an IG switch 4 of the vehicle 1 to the gateway 10.

The ECUs 2 may include various ECUs such as an ECU for controlling the operation of the engine, an ECU for controlling the locking/unlocking of the doors, an ECU for turning lights on/off, an ECU for controlling the operation of the air bags, and an ECU for controlling the operation of the ABS (antilock brake system) of the vehicle 1. Each ECU 2 is connected to the communication line 1a or 1b arranged in the vehicle 1, and can transmit and receive data to and from other ECUs 2 and the gateway 10 via the communication lines 1a and 1b.

The wireless communication apparatus 3a can transmit and receive information to and from the smartphone 7 by performing wireless communication such as Bluetooth (registered trademark) or NFC (near-field communication). The wireless communication apparatus 3a can perform wireless communication with the smartphone 7 that is within the coverage of wireless signals. In the present embodiment, the wireless communication apparatus 3a and the smartphone 7 do not communicate via a relay device that relays wireless signals and the like. In addition, the wireless communication apparatus 3a is connected to the gateway 10 via the communication line 1c, and can transmit and receive information to and from the gateway 10 through wired communication. Accordingly, the wireless communication apparatus 3a can relay communication performed between the gateway 10 and the smartphone 7, and transmits data provided from the gateway 10 to the smartphone 7, and provides data received from the smartphone 7 to the gateway 10.

The wireless communication apparatus 3b can transmit and receive information to and from the server apparatus 9 installed outside of the vehicle 1 by performing wireless communication through a mobile phone communication network, a wireless LAN (local area network), or the like. The wireless communication apparatus 3b can relay communication performed between the gateway 10 and the server apparatus 9, and transmits data provided from the gateway 10 to the server apparatus 9, and provides data received from the server apparatus 9 to the gateway 10. Note that, in the present embodiment, the wireless communication apparatus 3a that communicates with the smartphone 7 and the wireless communication apparatus 3b that communicates with the server apparatus 9 are different apparatuses, but there is no limitation thereto, and a configuration may be adopted in which only one wireless communication apparatus that communicates with the smartphone 7 and the server apparatus 9 is installed in the vehicle 1.

The gateway 10 is connected to the plurality of communication lines 1a to 1c that constitute the in-vehicle network of the vehicle 1, and performs processing for relaying data transmitted and received between the communication lines. In the example shown in FIG. 1, the gateway 10 is connected to the three communication lines 1a to 1c, specifically, the first communication line 1a to which two ECUs 2 and one display apparatus 5 are connected, the second communication line 1b to which three ECUs 2 are connected, and the third communication line 1c to which the wireless communication apparatuses 3a and 3b are connected. The gateway 10 transmits data received from one of the communication lines 1a to 1c to another one of the communication lines 1a to 1c, and thereby relays the data.

The IG switch 4 is a switch that allows the user to start the engine of the vehicle 1, and the like, and is switched between two states, namely an on state and an off state. The IG signal indicates the state of the IG switch 4, and the IG on state is a state where the motor of the vehicle 1 such as the engine is operating and electricity is generated by the alternator or the like, and the IG off state is a state where the motor of the vehicle 1 is stopped and electricity is not generated. In the present embodiment, the IG on state is set as the running state of the vehicle 1 regardless of the speed of the vehicle, and the IG off state is set as the parked state of the vehicle 1. Note that, the running state and the parked state of the vehicle 1 do not need to be distinguished based on the IG signal, and, for example, may be determined based on the position of the shift lever of the vehicle 1, the state of the parking brake, the running speed of the vehicle 1, or the like.

The display apparatus 5 is constituted by a liquid crystal display, for example, and displays a message to the user of the vehicle 1, according to a display instruction provided from an ECU 2 or the gateway 10, for example. In addition, the display apparatus 5 includes an operation unit 5a such as a touch panel or hardware keys, for example, receives a user's operation on the operation unit 5a, and notifies the ECUs 2 or the gateway 10 of the content of the received operation. Note that the display apparatus 5 may be shared with a car navigation apparatus, for example.

The smartphone 7 is a portable communication device held by the user of the vehicle 1, for example. The wireless communication apparatus 3a performs wireless communication with the smartphone 7 registered in advance. The smartphone 7 according to the present embodiment has a function for receiving signals from the GPS (Global Positioning System) satellite and detecting the position of the smartphone 7, for example. In addition, an application (application program) for transmitting and receiving information to and from the gateway 10 via the wireless communication apparatus 3a is installed in the smartphone 7. Note that, instead of the smartphone 7 and the gateway 10 communicating with each other via the wireless communication apparatus 3a, for example, a configuration may also be adopted in which communication is performed via a communication cable such as a USB (universal serial bus). In addition, in the present embodiment, the portable communication device that communicates with the wireless communication apparatus 3a is the smartphone 7, but there is no limitation thereto, and the portable communication device may also be a mobile phone, a tablet terminal apparatus, a notebook computer, or a game machine, for example.

The server apparatus 9 manages and stores programs and data executed by the ECUs 2 that are installed in the vehicle 1. In response to an inquiry from the vehicle 1, the server apparatus 9 notifies whether or not it is necessary to update a program or the like, and delivers an update program or data to the vehicle 1 if an update is necessary.

In the update system according to the present embodiment, when the IG switch 4 of the vehicle 1 is in the on state, the gateway 10 and the server apparatus 9 communicate with each other, and a program and/or data required for an update and the like is acquired (downloaded) from the server apparatus 9 to the gateway 10. If the IG switch 4 is switched to the off state after that, the gateway 10 that acquired the program and/or data required for an update and the like communicates with the smartphone 7 using the wireless communication apparatus 3a, and acquires position information. The gateway 10 compares the position information acquired from the smartphone 7 with the position information for permitting or prohibiting update processing registered in advance, and determines whether or not update processing can be performed. When the gateway 10 has determined based on the position information that update processing can be performed, it displays, on the display apparatus 5, a message for inquiring whether or not update processing can be executed, and receives a user's response to this message through the operation unit 5a. If the user permits update processing to be to executed, the gateway 10 transmits the update program and/or data acquired from the server apparatus 9 to the ECU 2 to be updated, and thereby causes this ECU 2 to execute update processing. And when the ECU 2 has received the program and/or data required for an update, and the like from the gateway 10, it performs update processing by writing this program and/or data, and the like to the storage unit of the ECU 2.

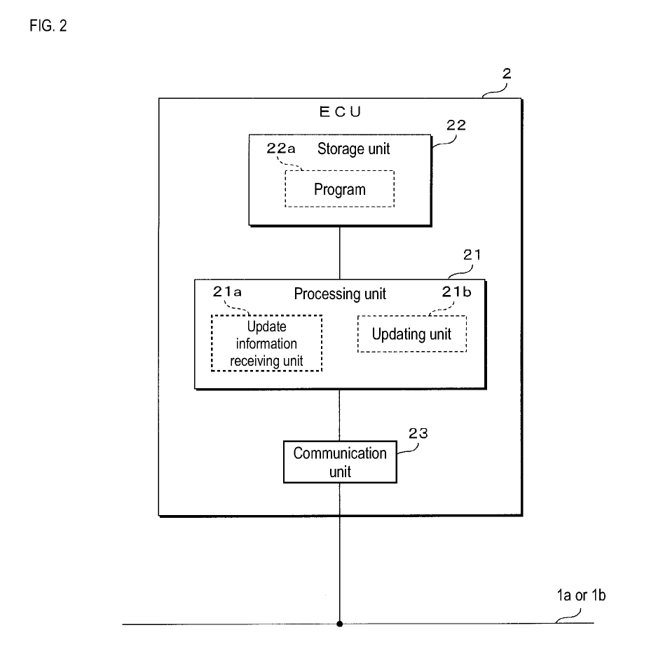

FIG. 2 is a block diagram showing the configuration of the ECU 2 according to the present embodiment. This diagram focuses on the functional blocks that all of the plurality of ECUs 2 have, and omits the functional blocks that are different in each ECU 2. Each of the ECUs 2 according to the present embodiment includes a processing unit 21, a storage unit 22, and a communication unit 23. The processing unit 21 is constituted, for example, by a computation processing unit such as a CPU (central processing unit) or an MPU (micro-processing unit), and performs various computations by reading out and executing a program 22a stored in the storage unit 22. The program 22a stored in the storage unit 22 is different in each ECU 2.

The storage unit 22 is constituted by a non-volatile memory element such as a flash memory or an EEPROM (electrically erasable programmable read only memory). The storage unit 22 stores the program 22a to be executed by the processing unit 21 and data necessary for executing this program 22a. Hereinafter, the term “program 22a” may encompass the program 22a and the data necessary for executing the program 22a.

The communication unit 23 is connected to the communication line 1a or 1b that constitutes the in-vehicle network, and transmits and receives data in accordance with a communication protocol of a CAN (controller area network) or the like. The communication unit 23 converts data provided from the processing unit 21 into an electric signal and outputs the electric signal to the communication line 1a or 1b so as to transmit the data, and samples and acquires the electrical potential at the communication line 1a or 1b so as to receive data, and provides the received data to the processing unit 21.

The processing unit 21 of each ECU 2 according to the present embodiment includes an update information receiving unit 21a a and an updating unit 21b. The update information receiving unit 21a and the updating unit 21b are functional blocks for updating the program 22a stored in the storage unit 22. The update information receiving unit 21a and the updating unit 21b are software-like functional blocks that are realized by the processing unit 21 executing a program (not illustrated) different from the program 22a to be updated. The update information receiving unit 21a receives an update program transmitted via the communication line 1a or 1b, using the communication unit 23, and accumulates the received update program in a buffer memory (not illustrated) or the like. The updating unit 21b performs processing for updating the program 22a by storing, to the storage unit 22, the update program accumulated in the buffer memory or the like (overwriting the program 22a before being updated).

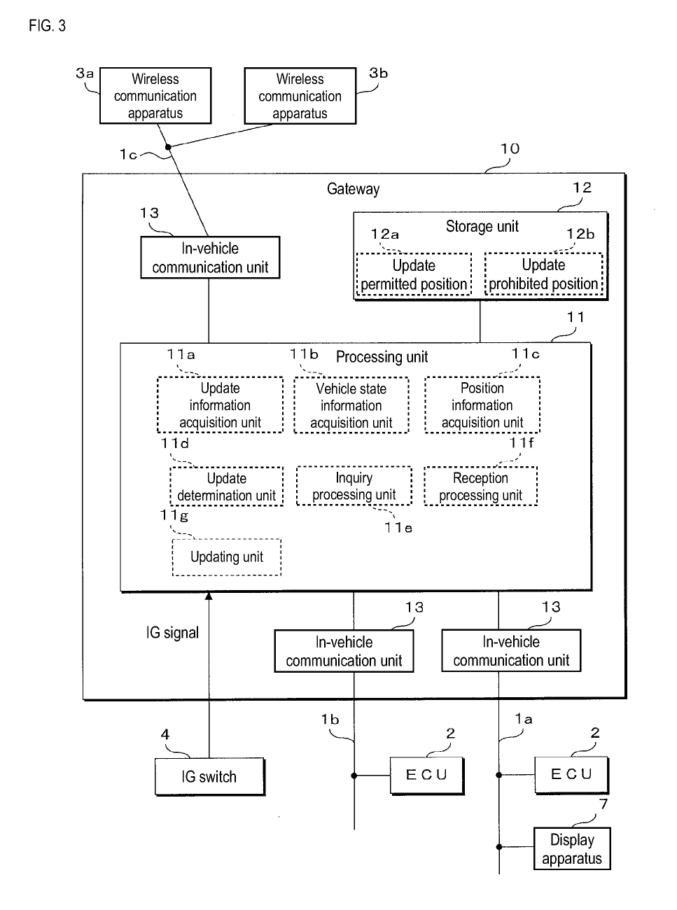

FIG. 3 is a block diagram showing the configuration of the gateway 10 according to the first embodiment. The gateway 10 according to the first embodiment includes a processing unit 11, a storage unit 12, and three in-vehicle communication units 13. The processing unit 11 is constituted by a computation processing unit such as a CPU or an MPU, and performs various computations by reading out and executing programs stored in the storage unit 12 or a ROM (read only memory, not illustrated), or the like. In the present embodiment, the processing unit 11 performs processing for relaying data transmitted and received between the communication lines 1a to 1c in the in-vehicle network, and performs the computations necessary for the update processing of the ECUs 2 or the like. In addition, the IG signal supplied from the IG switch 4 of the vehicle 1 is input to the processing unit 11. Note that the IG signal may also be input to the gateway 10 through in-vehicle communication in which the communication lines 1a to 1c are used.

The storage unit 12 is constituted by a non-volatile memory element such as a flash memory or EEPROM. The storage unit 12 stores programs, data, and the like used for updating the ECUs 2, for example. The storage unit 12 may store a program that is executed by the processing unit 11, data necessary for executing this program, and the like, and may also store data generated during the processing of the processing unit 11. Moreover, in the present embodiment, the storage unit 12 stores information regarding an update permitted position 12a, an update prohibited position 12b, and the like, in advance. The update permitted position 12a is information regarding a position at which the gateway 10 is permitted to execute update processing of programs or data of the ECUs 2. For example, when the user purchases the vehicle 1, the user performs an operation of registering one or more update permitted positions 12a as initial setting. The update prohibited position 12b is information regarding a position at which the gateway 10 is prohibited from executing update processing. The update prohibited position 12b is information that is set by the manufacturing company, distributor, or the like of the vehicle 1 in advance, for example. Positions that are not appropriate for executing update processing, due to which the vehicle cannot be used, such as, crime-filled regions, extremely hot or cold regions, and suburban regions such as deserts or mountains are set in advance as update prohibited positions 12b. Update processing permitted positions and update processing prohibited positions are represented as a combination of latitude and longitude, for example, and the storage unit 12 may store a plurality of permitted positions and prohibited positions.

Note that, in the present embodiment, a configuration is adopted in which the update permitted position 12a is set by the user, and the update prohibited position 12b is set by the manufacturing company, distributor, or the like of the vehicle 1, but there is no limitation thereto. For example, a configuration may also be adopted in which the update permitted position 12a is set by the manufacturing company, distributor, or the like of the vehicle 1. Also, for example, a configuration may also be adopted in which the update prohibited position 12b is set by the user. The update permitted position 12a and the update prohibited position 12b may be set by anyone, any time, and in any manner.

The in-vehicle communication units 13 are respectively connected to the communication lines 1a to 1c that constitute the in-vehicle network, and transmit and receive data in accordance with the CAN communication protocol or another communication protocol. The in-vehicle communication unit 13 converts data provided from the processing unit 11 into an electric signal, and outputs the electric signal to the communication lines 1a to 1c so as to transmit information, and samples and acquires the electrical potential at the communication lines 1a to 1c so as to receive data, and provides the received data to the processing unit 11. Each of the three in-vehicle communication units 13 provided in the gateway 10 may perform communication in accordance with different communication protocols.

The processing unit 11 executes the programs stored in the storage unit 12, the ROM, or the like, and thereby realizes, as software-like functional blocks, an update information acquisition unit 11a, a vehicle state information acquisition unit 11b, a position information acquisition unit 11c, an update determination unit 11d, an inquiry processing unit 11e, a reception processing unit 11f, an updating unit 11g, and the like. The update information acquisition unit 11a communicates with the server apparatus 9 via the wireless communication apparatus 3b at a predetermined timing, and inquires whether or not the programs 22a in the ECUs 2 installed in the vehicle 1 need to be updated. The predetermined timing at which an inquiry regarding necessity of updates is made may be set as a predetermined cycle (e.g., every day or every week), or the inquiry may be made every time the IG switch 4 of the vehicle 1 is turned from off to on, for example. When informed by the server apparatus 9 that a program needs to be updated, the update information acquisition unit 11a acquires a program, data, or the like necessary for updating the program (hereinafter, simply referred to as “update program”) from the server apparatus 9 via the wireless communication apparatus 3b, and stores the update program in the storage unit 12. The update information acquisition unit 11a acquires update programs for all of the ECUs 2 that need to be updated.

The vehicle state information acquisition unit 11b determines whether the IG signal is in the on state or the off state, by sampling and acquiring the value of the IG signal that is input from the IG switch 4, and determines whether the vehicle 1 is in the running state or the parked state according to the state of the IG signal. In other words, the vehicle state information acquisition unit 11b performs processing for acquiring the state of the vehicle 1 based on the IG signal.

When the state of the vehicle 1 that is acquired by the vehicle state information acquisition unit 11b changes from the running state to the parked state, the position information acquisition unit 11c communicates with the smartphone 7 via the wireless communication apparatus 3a, and performs processing for acquiring position information detected using a position detection function of the smartphone 7. When the vehicle 1 changes from the running state to the parked state, the position information acquisition unit 11c determines whether or not the registered smartphone 7 is in the communication range of the wireless communication apparatus 3a, and if the registered smartphone 7 is in the communication range of the wireless communication apparatus 3a, requests this smartphone 7 for position information. According to this request, position detection is performed in the smartphone 7, and the detected position information is transmitted to the wireless communication apparatus 3a. The position information acquisition unit 11c acquires the position information from the smartphone 7 received by the in-vehicle communication unit 13. This position information acquired by the position information acquisition unit 11c is regarded as position information when the vehicle 1 is in the parked state.

The update determination unit 11d performs processing for determining whether or not the current position of the vehicle 1 is a position at which update processing is permitted to be performed, by comparing the position information acquired by the position information acquisition unit 11c with the information regarding the update permitted position 12a and the update permitted position 12a stored in the storage unit 12. Note that, in the present embodiment, the update permitted position 12a is more preferentially determined than the update prohibited position 12b. Therefore, if the update permitted position 12a is stored in the storage unit 12 (in other words, if an update permitted position has been set by the user), it suffices for the update determination unit 11d to compare the current position with the update permitted position 12a. If the current position is the update permitted position 12a or is included in the update permitted position 12a, the update determination unit 11d determines that update processing can be performed. If the update permitted position 12a is not stored (in other words, if no update permitted position has been set by the user), the update determination unit 11d compares the current position with the update prohibited position 12b. If the current position is not the update prohibited position 12b or is not included in the update prohibited position 12b, the update determination unit 11d determines that update processing can be performed.

If the update determination unit 11d determines that update processing can be performed, the inquiry processing unit 11e performs processing for inquiring the user whether or not update processing of the ECUs 2 can be executed. The inquiry processing unit 11e displays, on the display apparatus 5, a message for inquiring whether or not update processing can be executed, by providing a message display instruction to the display apparatus 5 using the in-vehicle communication unit 13. For example, the inquiry processing unit 11e displays the message “Do you wish to execute ECU software update processing?” on the display apparatus 5. The user can respond to this inquiry by performing an input operation on the operation unit 5a of the display apparatus 5.

The reception processing unit 11f performs processing for receiving a user's response to an inquiry made by the inquiry processing unit 11e. The display apparatus 5 transmits the content of the user's input operation performed on the operation unit 5a, to the gateway 10. The reception processing unit 11f receives the user's response by acquiring the content of the user's operation on the operation unit 5a transmitted from the display apparatus 5 and received by the in-vehicle communication unit 13.

If the reception processing unit 11f receives, from the user, a response for permitting update processing, the updating unit 11g executes update processing on the ECU 2 to be updated. The updating unit 11g reads out an update program acquired by the update information acquisition unit 11a from the server apparatus 9 and stored in the storage unit 22, and transmits the read update program to the ECU 2 to be subjected to update processing, so as to execute update processing of the program 22a stored in the storage unit 22 of this ECU 2. The ECU 2 that received the update program from the gateway 10 performs update processing of the program 22a that is stored in the storage unit 22 and has not been updated, by overwriting the program 22a with the received update program.

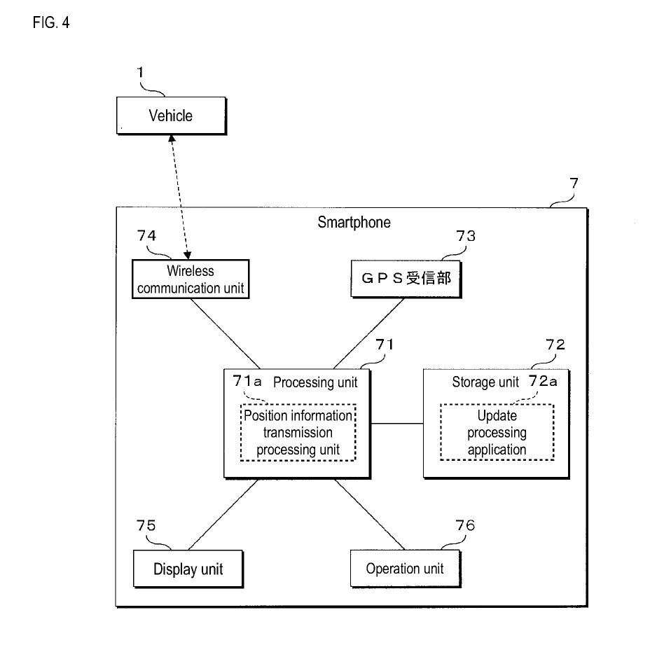

FIG. 4 is a block diagram showing the configuration of the smartphone 7 according to the first embodiment. Note that, in FIG. 4, functional blocks related to update processing of the ECUs 2 installed in the vehicle 1 are extracted from the functional blocks provided in the smartphone 7, and are shown, and functional blocks that are not related to update processing are not illustrated. The smartphone 7 according to the first embodiment includes a processing unit 71, a storage unit 72, a GPS receiving unit 73, a wireless communication unit 74, a display unit 75, an operation unit 76, and the like. The processing unit 71 is constituted by a computation processing apparatus such as a CPU or an MPU, and performs various computations by executing programs stored in the storage unit 72.

The storage unit 72 is constituted by a nonvolatile memory element such as a flash memory. The storage unit 72 stores programs that are executed by the processing unit 21, and data required for executing this program. In the present embodiment, as a program for performing processing related to update processing of the ECUs 2 of the vehicle 1, an update processing application 72a is stored in the storage unit 72. The update processing application 72a is downloaded in advance from a server apparatus that distributes applications, or the like, and is stored in the storage unit 72.

The GPS receiving unit 73 receives a wireless signal transmitted from the GPS satellite, and provides information included in the received signal to the processing unit 71. The wireless signal received by the GPS receiving unit 73 includes time information, and the processing unit 71 can perform position detection based on this information. The wireless communication unit 74 can transmit and receive information to and from the wireless communication apparatus 3a of the vehicle 1, by performing wireless communication such as Bluetooth (registered trademark) or NFC. The wireless communication unit 74 transmits information provided from the processing unit 71, to the wireless communication apparatus 3a of the vehicle 1, receives information transmitted by the wireless communication apparatus 3a, and provides the received information to the processing unit 71. The display unit 75 is constituted by a liquid crystal panel and the like, and displays various images provided from the processing unit 71. The operation unit 76 receives a user's operation through a touch panel, hardware keys, or the like, and provides the content of the received operation to the processing unit 71.

In addition, in the processing unit 71, as a result of the update processing application 72a stored in the storage unit 72 being executed, a position information transmission processing unit 71a and the like are realized as software-like functional blocks. The position information transmission processing unit 71a performs processing for detecting the position of the smartphone 7 based on information provided from the GPS receiving unit 73. In addition, the position information transmission processing unit 71a performs processing for transmitting information regarding the detected position of the smartphone 7 according to a request from the wireless communication apparatus 3a of the vehicle 1.

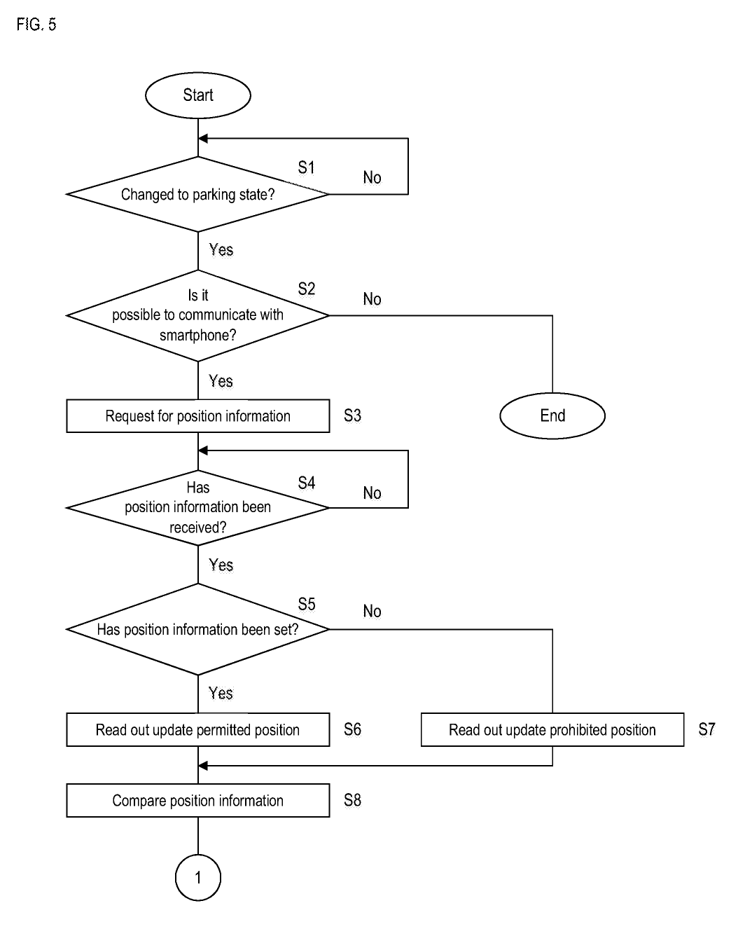

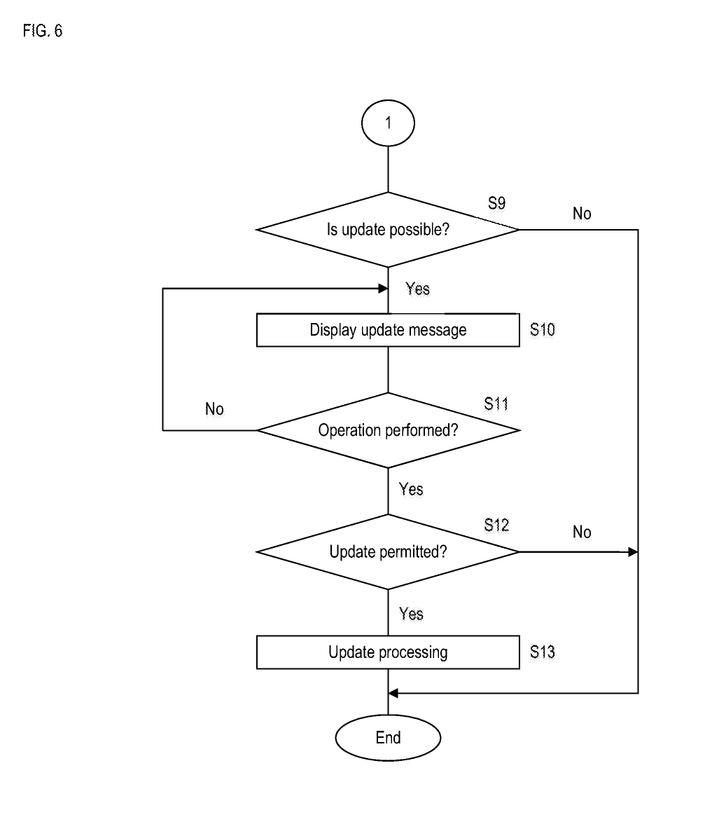

FIGS. 5 and 6 are flowcharts showing the procedure of processing that is performed by the gateway 10 according to the first embodiment. Note that this flowchart illustrates a procedure after the vehicle 1 enters the running state, and the update information acquisition unit 11a of the processing unit 11 of the gateway 10 acquires, from the server apparatus 9, an update program required for update processing of the ECU 2. The processing unit 11 of the gateway 10 according to the present embodiment causes the vehicle state information acquisition unit 11b to acquire the state information of the vehicle 1 based on the IG signal that is input from the IG switch 4, and determines whether or not the vehicle 1 has changed from the running state to the parked state (step S1). If the vehicle 1 has not changed to the parked state (step S1: NO), the processing unit 11 waits until the vehicle 1 changes to the parked state.

If the vehicle 1 has changed to the parked state (step S1: YES), the processing unit 11 determines whether or not it is possible to communicate with the smartphone 7, by attempting to communicate with the smartphone 7 registered in advance using the wireless communication apparatus 3a (step S2). If it is not possible to communicate with the smartphone 7 (step S2: NO), the processing unit 11 ends the processing without performing update processing. If it is possible to communicate with the smartphone 7 (step S2: YES), the position information acquisition unit 11c of the processing unit 11 requests the smartphone 7 to acquire position information, using the wireless communication apparatus 3a (step S3). Position information is transmitted from the smartphone 7 according to this request. The position information acquisition unit 11c determines whether or not position information transmitted from the smartphone 7 has been received by the wireless communication apparatus 3a (step S4). If position information has not been received (step S4: NO), the position information acquisition unit 11c waits until position information is received.

If position information is received from the smartphone 7 (step S4: YES), the update determination unit 11d of the processing unit 11 determines whether or not a position at which update processing is permitted has been set, based on whether or not the update permitted position 12a is stored in the storage unit 12 (step S5). If a permitted position has been set (step S5: YES), the update determination unit 11d reads out the update permitted position 12a from the storage unit 12 (step S6), and advances the procedure to step S8. If no permitted position has been set (step S5: NO), the update determination unit 11d reads out the update prohibited position 12b from the storage unit 12 (step S7), and advances the procedure to step S8.

The update determination unit 11d compares the position information received from the smartphone 7 with the update permitted position 12a read out in step S6 or the update prohibited position 12b read out in step S7 (step S8). The update determination unit 11d determines whether or not update processing of the ECUs 2 can be executed, based on the comparison result of the position information (step S9). If it is determined that update processing cannot be executed (step S9: NO), the processing unit 11 ends the procedure without performing update processing.

If it is determined that update processing can be performed (step S9: YES), the inquiry processing unit 11e of the processing unit 11 provides a display instruction to the display apparatus 5 using the in-vehicle communication unit 13, so as to display, on the display apparatus 5, an update message for inquiring whether or not update processing can be performed (step S10). Next, the reception processing unit 11f of the processing unit 11 determines whether or not a user's operation has been performed on the operation unit 5a of the display apparatus 5, based on whether or not notification of the content of a user's operation has been received from the display apparatus 5 using the in-vehicle communication unit 13 (step S11). If a user's operation has not been performed (step S11: NO), the processing unit 11 returns the procedure to step S10, and continues display of the update message.

If a user's operation has been performed on the operation unit 5a (step S11: YES), the reception processing unit 11f determines whether or not the content of the user's operation notified from the display apparatus 5 is an operation for permitting update processing (step S12). If the user's operation is not an operation for permitting update processing (step S12: NO), the processing unit 11 ends the procedure without executing update processing. If the user's operation is an operation for permitting update processing (step S12: YES), the updating unit 11g of the processing unit 11 reads out an update program stored in the storage unit 12, and transmits the update program to the ECU 2 to be subjected to update processing, so as to cause this ECU 2 to execute update processing (step S13), and ends the procedure.

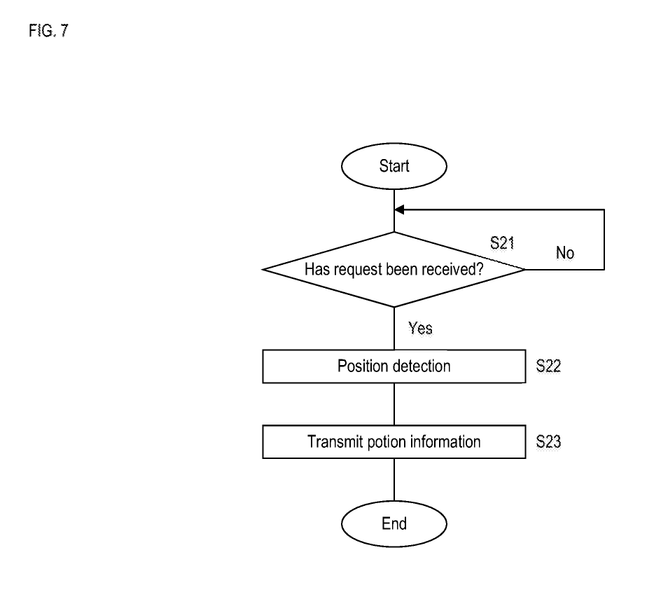

FIG. 7 is a flowchart showing the procedure of processing that is performed by the smartphone 7 according to the first embodiment. The processing unit 71 of the smartphone 7 determines whether or not a request for position information has been received from the vehicle 1 using the wireless communication unit 74 (step S21). If no request has been received (step S21: NO), the processing unit 71 waits until the request is received. If a request has been received (step S21: YES), the position information transmission processing unit 71a of the processing unit 71 detects the position of the smartphone 7 based on information provided from the GPS receiving unit 73 (step S22). Next, the position information transmission processing unit 71a transmits the detected position information to the vehicle 1 through the wireless communication unit 74 (step S23), and ends the procedure.

In the update system according to the present embodiment that has the above-described configuration, update processing of the programs 22a stored in the storage unit 22 of the ECUs 2 is performed by the gateway 10. The gateway 10 stores, to the storage unit 12, the update permitted position 12a and the update prohibited position 12b, as information regarding whether or not update processing can be executed. Before executing update processing of the ECUs 2, the gateway 10 compares the position information of the vehicle 1 at this point with the position information stored in the storage unit 12, and determines whether or not update processing can be executed. If it is determined, based on the position information, that update processing can be performed, the gateway 10 transmits an update program to the ECU 2 to be updated so as to execute update processing. Accordingly, update processing of the ECU 2 is performed at a position at which execution of update processing is permitted, and update processing is not performed at a position at which execution of update processing is not permitted. For example, by setting position information of the user's home as the update permitted position 12a, update processing is not performed at a position other than this position, and it is possible to prevent the user from being unable to use the vehicle due to update processing when the user is out in the vehicle.

In addition, the gateway 10 according to the present embodiment acquires state information of the vehicle 1 based on the IG signal that is input from the IG switch 4, and when the vehicle 1 changes from the running state to the parked state, determines whether or not update processing can be executed. Accordingly, update processing can be executed in a safe state where the vehicle 1 is not running.

In addition, if it is determined that update processing can be executed, the gateway 10 according to the present embodiment makes an inquiry on whether or not to perform update processing by displaying a message on the display apparatus 5, and receives, from the user, a response regarding whether or not update processing can be performed, using the operation unit 5a of the display apparatus 5. Note that the gateway 10 does not make an inquiry to the user if it is determined that update processing cannot be executed. Accordingly, the inquiry is made to the user only at a position at which update processing can be executed, and it is possible to reduce the user's irritations from frequently repeated inquiries, and it is possible to prevent update processing from being permitted due to the inquiry being made at a position at which update processing cannot be performed and the user performing an erroneous operation.

In addition, the gateway 10 according to the present embodiment communicates with the smartphone 7 held by the user of the vehicle 1, via the wireless communication apparatus 3a. The smartphone 7 has a function for performing position detection based on a GPS signal received by the GPS receiving unit 73, and the gateway 10 acquires position information detected by the smartphone 7, and determines whether or not update processing can be performed, based on the position information. Accordingly, even if no apparatus that detects position information is installed in the vehicle 1, the gateway 10 can perform determination processing that is based on position information.

In addition, the gateway 10 according to the present embodiment stores, in the storage unit 12, a position at which update processing is permitted, as the update permitted position 12a, as the information regarding whether or not update processing can be executed. Accordingly, for example, by the user of the vehicle 1 registering his or her parking lot in advance as a position at which update processing is permitted, it is possible to easily limit a position at which update processing is performed.

In addition, the gateway 10 according to the present embodiment stores, in the storage unit 12, a position at which update processing is prohibited, as the update prohibited position 12b, as the information regarding whether or not update processing can be executed. Accordingly, for example, safety measures can be taken in which the manufacturing company, distributor, or the like of the vehicle 1 registers, in advance, positions that are not appropriate for executing update processing, due to which the vehicle 1 cannot be used, such as crime-filled regions, extremely hot or cold regions, and suburban regions such as deserts or mountains.

Note that, in the present embodiment, the on-board device to be subjected to update processing is the ECU 2, but there is no limitation thereto, and any on-board device other than the ECU 2 may be subj ected to update processing. In addition, the on-board update apparatus that performs update processing of the ECU 2 is the gateway 10, but there is no limitation thereto. For example, a configuration may be adopted in which one of the ECUs 2 installed in the vehicle 1 performs update processing, and, for example, a configuration may also be adopted in which the wireless communication apparatuses 3a and 3b, the display apparatus 5, or an apparatus such as a car navigation apparatus installed in the vehicle 1 performs update processing. In addition, a configuration is adopted in which the gateway 10 communicates with the server apparatus 9 via the wireless communication apparatus 3b, but there is no limitation thereto, and, for example, a configuration may be adopted in which the gateway 10 communicates with the server apparatus 9 via the smartphone 7.

In addition, a configuration is adopted in which the gateway 10 acquires, from the server apparatus 9, an update program used for update processing of an ECU 2, but there is no limitation thereto. For example, a configuration may be adopted in which an update program is recorded in a recording medium such as a memory card or an optical disk, and the gateway 10 or one of the on-board devices installed in the vehicle 1 acquires the update program from the recording medium. In addition, for example, a configuration may be adopted in which the gateway 10 acquires an update program from a portable communication device such as the smartphone 7.

In addition, in the present embodiment, a configuration is adopted in which the gateway 10 acquires an update program from the server apparatus 9, stores the program to the storage unit 12, and, after that, performs a determination that is based on position information, makes an inquiry to the user, and the like, but there is no limitation thereto. For example, a configuration may be adopted in which the gateway 10 first performs the determination based on position information and makes an inquiry to the user, and if execution of update processing is permitted, acquires an update program from the server apparatus 9, and transmits the update program to the ECU 2. In addition, for example, if an ECU 2 has an extra memory (an external memory, an extra storage region, etc.) for storing an update program, a configuration may be adopted in which, after the gateway 10 transmits an update program acquired from the server apparatus 9, to the ECU 2, and this update program is stored in the extra memory of the ECU 2, the gateway 10 performs a determination that is based on position information, makes an inquiry to the user, and the like. In this configuration, it is sufficient that, if execution of update processing is permitted, the gateway 10 informs the ECU 2 that execution of update processing is permitted.

In addition, a configuration is adopted, in which the gateway 10 uses two pieces of position information, namely the update permitted position 12a and the update prohibited position 12b as information regarding whether or not update processing can be executed, there is no limitation thereto, and a configuration may be adopted in which only one of the update permitted position 12a and the update prohibited position 12b is used. In addition, a plurality of positions may be set as the update permitted position 12a and the update prohibited position 12b. In addition, a configuration is adopted in which the gateway 10 displays a message for inquiring whether or not update processing can be performed, on the display apparatus 5, but there is no limitation thereto, and, for example, the message may also be displayed on the display unit 75 of the smartphone 7, or may be displayed on another apparatus. Similarly, a configuration is adopted in which the gateway 10 receives a user's input operation in response to the inquiry, through the operation unit 5a of the display apparatus 5, but there is no limitation thereto, and, for example, the user's input operation may be received by the operation unit 76 of the smartphone 7, or may be received by another apparatus.

### Modified Example

In addition, in the update system according to the present embodiment, a configuration is adopted in which position detection is performed by the smartphone 7, but there is no limitation thereto. For example, a configuration may be adopted in which the gateway 10 is provided with a GPS receiving unit that receives a GPS wireless signal. In the case of this configuration, it is sufficient that the gateway 10 detects the position based on information included in a signal received by the GPS receiving unit of the gateway 10, instead of acquiring position information via the smartphone 7. In addition, a configuration may be adopted in which another on-board device such as a car navigation apparatus installed in the vehicle 1 is provided with a GPS receiving unit instead of the gateway 10 being provided with the GPS receiving unit. In the case of this configuration, it is sufficient that the gateway 10 acquires position information from another on-board device provided with a GPS receiving unit, by performing communication via the in-vehicle communication unit 13. Note, that in the configuration in which the vehicle 1 is provided with the GPS receiving unit, the smartphone 7 is not necessarily required.

### Second Embodiment

The above-described update system according to the first embodiment adopts a configuration in which the gateway 10 performs determination processing based on position information, but there is no limitation thereto. An update system according to a second embodiment adopts a configuration in which a smartphone performs determination processing based on position information, and a gateway acquires the determination result from the smartphone.

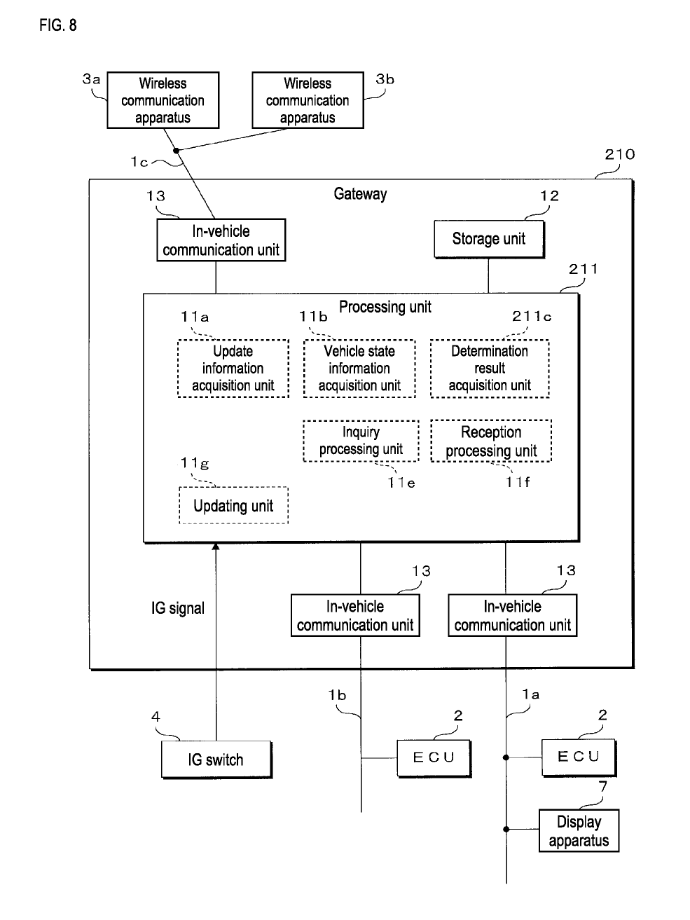

FIG. 8 is a block diagram showing the configuration of a gateway 210 according to the second embodiment. In the gateway 210 according to the second embodiment, a processing unit 211 is not provided with functional blocks such as the position information acquisition unit 11c and the update determination unit 11d, and is provided with a determination result acquisition unit 211c instead. In addition, an update permitted position 12a and an update prohibited position 12b are not stored in a storage unit 12 of the gateway 210.

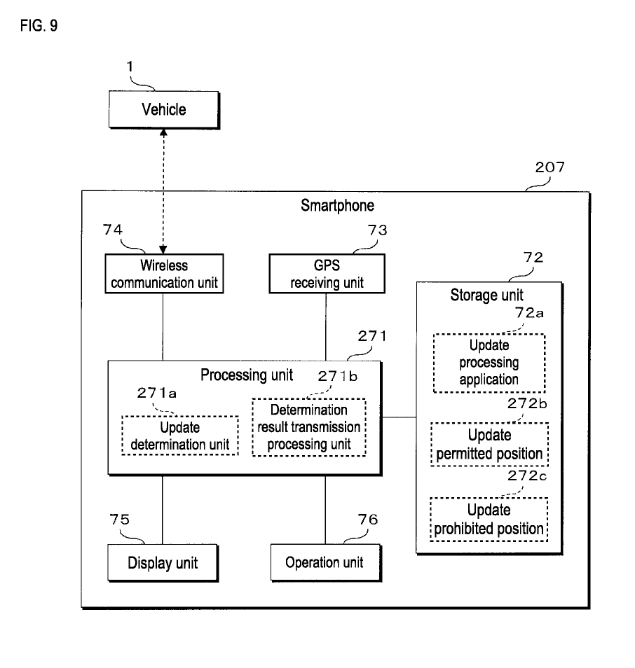

FIG. 9 is a block diagram showing the configuration of a smartphone 207 according to the second embodiment. In the smartphone 207 according to the second embodiment, a processing unit 271 is provided with functional blocks such as an update determination unit 271a and a determination result transmission processing unit 271b, instead of the functional block such as the position information transmission processing unit 71a. In addition, an update permitted position 272b and an update prohibited position 272c are stored in a storage unit 72 of the smartphone 207 along with an update processing application 72a.

In the update system according to the second embodiment, in place of the gateway 210, the smartphone 207 determines whether or not update processing can be executed, based on position information. In the gateway 210, if the state of a vehicle 1 that is acquired by a vehicle state information acquisition unit 11b changes from a running state to a parked state, the determination result acquisition unit 211c of the processing unit 211 communicates with the smartphone 207 via a wireless communication apparatus 3a, and requests the smartphone 207 to determine whether or not update processing can be executed based on position information, and to transmit the determination result.

The update determination unit 271a of the processing unit 271 of the smartphone 207 that received this request performs position detection that is based on a signal received by a GPS receiving unit 73, compares the detected position with the update permitted position 272b and the update prohibited position 272c stored in the storage unit 72, and determines whether or not update processing can be executed. The determination result transmission processing unit 271b of the processing unit 271 transmits the determination result of the update determination unit 271a to the vehicle 1 using a wireless communication unit 74.

In the gateway 210 that received, from the smartphone 207, the determination result on whether or not update processing can be executed, if the received determination result indicates that update processing can be executed, an inquiry processing unit 11e inquires the user whether or not update processing can be performed. If a determination result indicating that update processing cannot be executed is received, the gateway 210 waits for the next opportunity (at the next timing when the vehicle 1 changes from the running state to the parked state) without performing update processing.

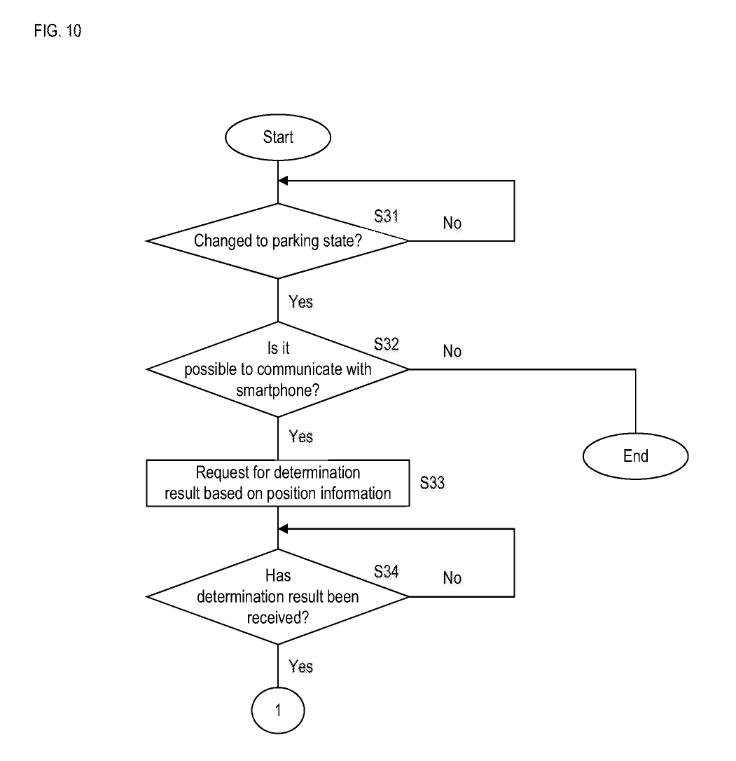

FIG. 10 is a flowchart showing the procedure of processing that is performed by the gateway 210 according to the second embodiment. Note that, this flowchart shows a procedure after the vehicle 1 enters the running state, and an update information acquisition unit 11a of the processing unit 211 of the gateway 210 acquires, from a server apparatus 9, update programs required for updating processing of the ECUs 2. The processing unit 211 of the gateway 210 according to the second embodiment determines whether or not the vehicle 1 has changed from the running state to the parked state, as a result of a vehicle state information acquisition unit 11b acquiring state information of the vehicle 1, based on an IG signal that is input from an IG switch 4 (step S31). If the vehicle 1 has not changed to the parked state (step S31: NO), the processing unit 211 waits until the vehicle 1 changes to the parked state.

When the vehicle 1 changes to the parked state (step S31: YES), the processing unit 211 attempts to communicate with the smartphone 207 registered in advance using the wireless communication apparatus 3a, and thereby determines whether or not it is possible to communicate with the smartphone 207 (step S32). If it is not possible to communicate with the smartphone 207 (step S32: NO), the processing unit 211 ends the procedure without performing update processing. If it is possible to communicate with the smartphone 207 (step S32: YES), the determination result acquisition unit 211c of the processing unit 211 requests the smartphone 207 to acquire a determination result on whether or not update processing can be performed based on the position information, using the wireless communication apparatus 3a (step S33). According to this request, a determination result is transmitted from the smartphone 207. The determination result acquisition unit 211c determines whether or not a determination result transmitted the smartphone 207 has been received by the wireless communication apparatus 3a (step S34). If no determination result has been received (step S34: NO), the determination result acquisition unit 211c waits until a determination result is received. If a determination result has been received (step S34: YES), the processing unit 211 determines whether or not update processing of the ECUs 2 can be executed, based on the received determination result (see step S9 in FIG. 6). Subsequent processing that is performed by the gateway 210 is the same as in the flowchart shown in FIG. 6, and thus a description thereof is omitted.

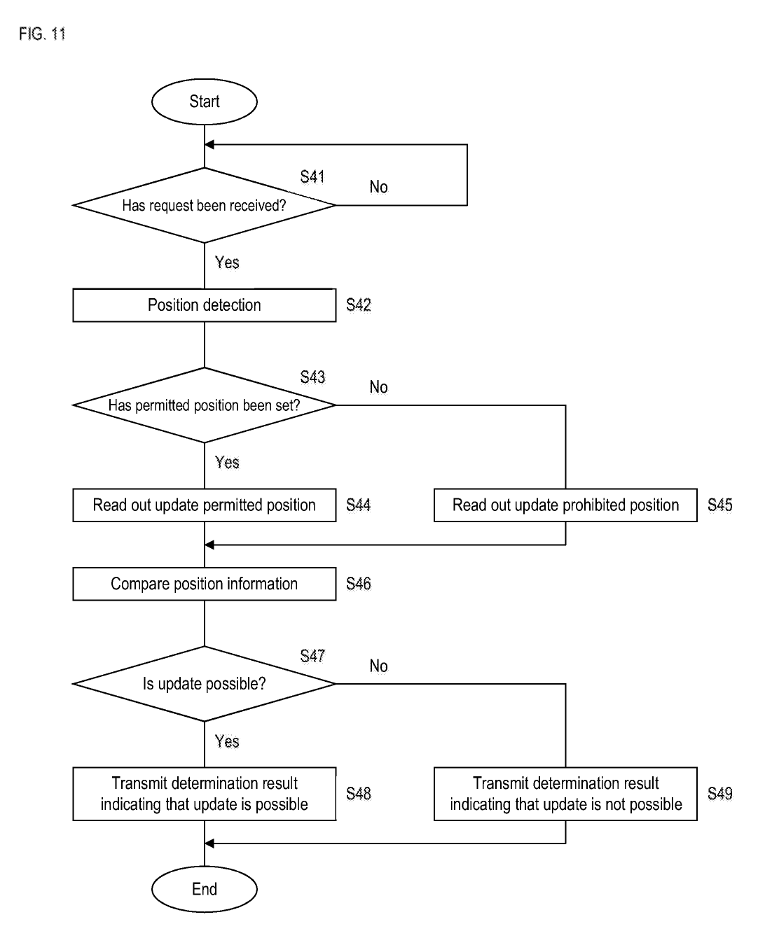

FIG. 11 is a flowchart showing the procedure of processing that is performed by the smartphone 207 according to the second embodiment. The processing unit 271 of the smartphone 207 determines whether or not a request for a determination result on whether or not update processing can be executed has been received from the vehicle 1 using the wireless communication unit 74 (step S41). If no request has been received (step S41: NO), the processing unit 271 waits until a request is received. If a request has been received (step S41: YES), the update determination unit 271a of the processing unit 271 detects the position of the smartphone 207 based on information provided from the GPS receiving unit 73 (step S42).

Next, the update determination unit 271a determines whether or not a position at which update processing is permitted has been set, based on whether or not the update permitted position 272b is stored in the storage unit 72 (step S43). If a permitted position has been set (step S43: YES), the update determination unit 271a reads out the update permitted position 272b from the storage unit 72 (step S44), and advances the procedure to step S46. If no permitted position has been set (step S43: NO), the update determination unit 271a reads out the update prohibited position 272c from the storage unit 72 (step S45), and advances the procedure to step S46.

The update determination unit 271a compares the position information detected in step S42 with the update permitted position 272b read out in step S44 or the update prohibited position 272c read out in step S45 (step S46). The update determination unit 271a determines whether or not update processing of the ECUs 2 can be executed, based on the comparison result of position information (step S47). If it is determined that update processing can be performed (step S47: YES), the determination result transmission processing unit 271b of the processing unit 271 transmits, to the vehicle 1, a determination result indicating that update processing can be performed, using the wireless communication unit 74 (step S48), and ends the procedure. If it is determined that update processing cannot be performed (step S47: NO), the determination result transmission processing unit 271b transmits a determination result indicating that update processing cannot be performed (step S49), and ends the procedure.

The update system of the above-described configuration according to the second embodiment has a configuration in which the smartphone 207 that has a position detection function stores, in the storage unit 72, the update permitted position 272b and the update prohibited position 272c as position information regarding execution of update processing of the ECUs 2, determines based on the position information whether or not update processing can be executed, according to a request from the gateway 210 of the vehicle 1, and transmits the determination result to the gateway 210. The gateway 210 receives the determination result from the smartphone 207, and if a determination result indicating that update processing can be performed is obtained, executes update processing of the ECUs 2. Accordingly, the gateway 210 does not need to store information regarding an update permitted position, an update prohibited position, and the like to the storage unit 12, and it is also unnecessary to perform processing for determining based on the position information whether or not update processing can be performed, and thus it is possible to reduce the processing load of the gateway 210, and reduce the cost of the gateway 210.

Note that the update system according to the present embodiment has a configuration in which, if the smartphone 207 determines that update processing can be performed, the gateway 210 uses the display apparatus 5 to inquire the user whether or not update can be performed, and to receive a user operation in response to this inquiry, but there is no limitation thereto. For example, a configuration may be adopted in which the smartphone 207 makes an inquiry to the user and receives an operation. In the case of this configuration, after determining that update processing can be performed based on position information, the smartphone 207 inquires the user whether or not update processing can be performed, receives a user's operation in response to this inquiry, and transmits the content of the received operation (in other words, whether or not update processing is permitted) to the gateway 210. If it is determined based on position information that update processing cannot be performed, it is sufficient that the smartphone 207 transmits a determination result indicating that update processing cannot be performed, to the gateway 210, without making an inquiry to the user nor receiving an operation. If notified from the smartphone 207 that a user operation for permitting the update has been received, the gateway 210 executes update processing of the ECUs 2. If notified from the smartphone 207 that it is determined, based on position information, that update processing cannot be performed, or a user operation for prohibiting the update has been received, the gateway 210 does not execute update processing of the ECUs 2.

In addition, other configurations of the update system according to the second embodiment are similar to those of the update system according to the first embodiment, and thus the same reference numerals are assigned to similar constituent elements, and a detailed description thereof is omitted.
FIG. 1
3a Wireless communication apparatus
3b Wireless communication apparatus
4 IG switch
5 Display apparatus
5a Operation unit
7 Smartphone
9 Server apparatus
10 Gateway
FIG. 2
22 Storage unit
22a Program
21 Processing unit
21a Update information receiving unit
21b Updating unit
23 Communication unit
1a [symbol] 1b 1a or 1b
FIG. 3
3a Wireless communication apparatus
3b Wireless communication apparatus
4 IG switch
7 Display apparatus
10 Gateway
11a Update information acquisition unit
11b Vehicle state information acquisition unit
11c Position information acquisition unit
11d Update determination unit
11e Inquiry processing unit
11f Reception processing unit
11g Updating unit
12 Storage unit
12a Update permitted position
12b Update prohibited position
13 In-vehicle communication unit
IG [symbol] IG signal
FIG. 4
1 Vehicle
7 Smartphone
71 Processing unit
71a Position information transmission processing unit
72 Storage unit
72a Update processing application
73 GPS receiving unit
74 Wireless communication unit
75 Display unit
76 Operation unit
FIG. 5
[symbol] Start
S1 Changed to parking state?
S2 Is it possible to communicate with smartphone?
[symbol] End
S3 Request for position information
S4 Has position information been received?
S5 Has position information been set?
S6 Read out update permitted position
S7 Read out update prohibited position
S8 Compare position information
FIG. 6
S9 Is update possible?
S10 Display update message
S11 Operation performed?
S12 Update permitted?
S13 Update processing
[symbol] End
FIG. 7
[symbol] Start
S21 Has request been received?
S22 Position detection
S23 Transmit portion information
[symbol] End
FIG. 8
3a Wireless communication apparatus
3b Wireless communication apparatus
210 Gateway
211 Processing unit
4 IG switch
7 Display apparatus
11a Update information acquisition unit
11b Vehicle state information acquisition unit
211c Determination result acquisition unit
11e Inquiry processing unit
11f Reception processing unit
11g Updating unit
12 Storage unit
13 In-vehicle communication unit
IG [symbol] IG signal
FIG. 9
1 Vehicle
207 Smartphone
72 Storage unit
72a Update processing application
272b Update permitted position
272c Update prohibited position
271 Processing unit
271a Update determination unit
271b Determination result transmission processing unit
73 GPS receiving unit
74 Wireless communication unit
75 Display unit
76 Operation unit
FIG. 10
[symbol] Start
S31 Changed to parking state?
S32 Is it possible to communicate with smartphone?
[symbol] End
S33 Request for determination result based on position information
S34 Has determination result been received?
FIG. 11
[symbol] Start
S41 Has request been received?
S42 Position detection
S43 Has permitted position been set?
S44 Read out update permitted position
S45 Read out update prohibited position
S46 Compare position information
S47 Is update possible?
S48 Transmit determination result indicating that update is possible
S49 Transmit determination result indicating that update is not possible
[symbol] End

1. An on-board update apparatus for causing an on-board device installed in a vehicle to execute update processing for updating a program or data stored in a storage unit of the on-board device, comprising:
a position information acquisition unit configured to acquire position information;
a position information storage unit configured to store position information for prohibiting execution of the update processing;
an update determination unit configured to determine whether or not the update processing can be executed, based on the position information acquired by the position information acquisition unit and the position information stored in the position information storage unit; and
an updating unit configured to, if the update determination unit determines that the update processing can be executed, cause the on-board device to execute the update processing.

2. The on-board update apparatus according to claim 1, further comprising:
a vehicle state information acquisition unit configured to acquire state information regarding running of the vehicle,
wherein, when the vehicle changes from a running state to a parked state, the update determination unit determines whether or not the update processing can be executed, based on the state information acquired by the vehicle state information acquisition unit.

3. The on-board update apparatus according to claim 1, further comprising:
an inquiry unit configured to, if the update determination unit determines that the update processing can be executed, inquire whether or not the update processing can be performed; and
a receiving unit configured to receive a response regarding whether or not the update processing can be performed, to the inquiry of the inquiry unit.

4. The on-board update apparatus according to claim 1, comprising:
a communication unit configured to communicate with a portable communication device that has a position detection unit configured to detect position information,
wherein the position information acquisition unit acquires position information from the portable communication device.

5. An update system that performs update processing for updating a program or data stored in a storage unit of an on-board device installed in a vehicle, comprising:
a portable communication device that has a position detection unit configured to detect position information; and
an on-board update apparatus that has:
a position information acquisition unit configured to acquire position information from the portable communication device,
a position information storage unit configured to store position information for prohibiting execution of the update processing,
an update determination unit configured to determine whether or not the update processing can be executed, based on the position information acquired by the position information acquisition unit and the position information stored in the position information storage unit, and
an updating unit configured to, if the update determination unit determines that the update processing can be executed, cause the on-board device to execute the update processing.

6. An update system that performs update processing for updating a program or data stored in a storage unit of an on-board device installed in a vehicle, comprising:
a portable communication device that has:
a position detection unit configured to detect position information,
a position information storage unit configured to store position information for permitting or prohibiting execution of the update processing, and
an update determination unit configured to determine whether or not the update processing can be executed, based on the position information detected by the position detection unit and the position information stored in the position information storage unit; and
an on-board update apparatus that has:
a determination result acquisition unit configured to acquire, from the portable communication device,
a determination result on whether or not the update processing can be executed, and
an updating unit configured to cause the on-board device to execute the update processing, if it is determined that the update processing can be executed, based on the determination result on whether or not the update processing can be executed acquired by the determination result acquisition unit.

7. A portable communication device comprising:
a position detection unit configured to detect position information;
a position information storage unit configured to store position information for permitting or prohibiting execution of update processing for updating a program or data stored in a storage unit of an on-board device installed in a vehicle;
an update determination unit configured to determine whether or not the update processing can be executed, based on the position information detected by the position detection unit and the position information stored in the position information storage unit; and
a determination result transmission unit configured to transmit a determination result of the update determination unit to an on-board update apparatus that performs the update processing.

8. The on-board update apparatus according to claim 2, further comprising:
an inquiry unit configured to, if the update determination unit determines that the update processing can be executed, inquire whether or not the update processing can be performed; and
a receiving unit configured to receive a response regarding whether or not the update processing can be performed, to the inquiry of the inquiry unit.

9. The on-board update apparatus according to claim 2, comprising:
a communication unit configured to communicate with a portable communication device that has a position detection unit configured to detect position information,
wherein the position information acquisition unit acquires position information from the portable communication device.

10. The on-board update apparatus according to claim 3, comprising:
a communication unit configured to communicate with a portable communication device that has a position detection unit configured to detect position information,
wherein the position information acquisition unit acquires position information from the portable communication device.
